(19) United States
(12) Patent Application Publication
(10) Pub. No.: US 2006/0162576 A1
(43) Pub. Date: Jul. 27, 2006

(54) Smoking system

(76) Inventor: Anthony Robert Upton, Hillston (AU)

Correspondence Address: Mark J. Pandiscio;Pandiscio & Pandiscio, P.C., 470 Totten Pond Road, Waltham, MA, 02451-1914, US

(21) Appl. No.: 11/337,432

(22) Filed: Jan. 23, 2006

(30) Foreign Application Priority Data
Jan. 25, 2005 (AU) 2005900303

(51) Int. Cl. F24B 3/00; A47J 37/00; A01J 15/14

(52) U.S. Cl. 99/467; 126/25 R; 422/126

(57) ABSTRACT

A smoking system comprising a burner having a combustion chamber, and a combustible charge for combustion therein; wherein the combustion chamber is a flue having an adjustable air inlet, and the combustible charge is shaped to frictionally engage the walls of the flue to be supported thereby within the flue, and is made from an odoriferous smoke generating material and is adapted to smoulder during combustion within the flue.

### TECHNICAL FIELD

This invention relates to a smoking system.

The invention has particular application to a system wherein a wafer of odoriferous smoke generating material smoulders in a combustion chamber.

### BACKGROUND OF INVENTION

It is known to smoulder a cube or pellet of an odoriferous smoke generating material for the purpose of imparting a pleasant smell to an area, or to flavour food when being cooked. My Australian Petty Patent 676128 discloses a so called barbeque bead made from Eucalyptus leaves for this purpose. The specification of Petty Patent 676128 is incorporated herein by reference.

### SUMMARY OF INVENTION

The present invention aims to provide an alternative to known apparatus, methods and systems for generating smoke.

This invention in one aspect resides broadly in smoking system including:

a burner having a combustion chamber, and

a combustible charge for combustion therein;

wherein:

the combustion chamber is a flue having an adjustable air inlet, and

the combustible charge is shaped to frictionally engage the walls of the flue to be supported thereby within the flue, and is made from an odoriferous smoke generating material and is adapted to smoulder during combustion within the flue.

It is preferred that the smoking system includes an ash chamber, wherein the ash chamber and the combustion chamber constitute a tube open at one end and extending beyond an aperture which constitutes the air inlet to a closed end, the space between the closed end and the aperture constituting the ash chamber and the space between the open end and the aperture constituting the combustion chamber.

It is also preferred that the adjustable air inlet includes a sleeve with an aperture, the sleeve being moveable relative to the tube so that the passageway formed by overlap of the sleeve aperture and the tube aperture varies in accordance with the position of the sleeve.

It is also preferred that the smoking system includes a removable cap to cover the open end of the tube, the cap having an aperture therein.

It is preferred that the combustible charge is substantially plate- or wafer-like. As used herein the expression “substantially plate- or wafer-like” is to be given a broad meaning and refers to any three dimensional solid, one dimension of which is substantially less than the other two.

In this embodiment it is preferred that the substantially plate- or wafer-like combustible charge has two opposed substantially parallel edge portions spaced apart a distance slightly greater than the internal diameter of the tube such that the charge is supported in the tube along the opposed edge portions.

### DESCRIPTION OF DRAWINGS

In order that this invention may be more easily understood and put into practical effect, reference will now be made to the accompanying drawings which illustrate a preferred embodiment of the invention, wherein:

FIG. 1 is an exploded perspective view of the burner in accordance with a preferred embodiment of the invention;

FIG. 2 is a perspective view of a first combustible charge of plate- or wafer-like configuration in accordance with a preferred embodiment of the invention;

FIG. 3 is a perspective view of a second combustible charge of plate- or wafer-like configuration in accordance with another preferred embodiment of the invention, and

FIG. 4 is a perspective view showing in dotted outline the combustible charge of FIG. 2 positioned for ignition within the burner of FIG. 1.

### DESCRIPTION OF PREFERRED EMBODIMENT OF INVENTION

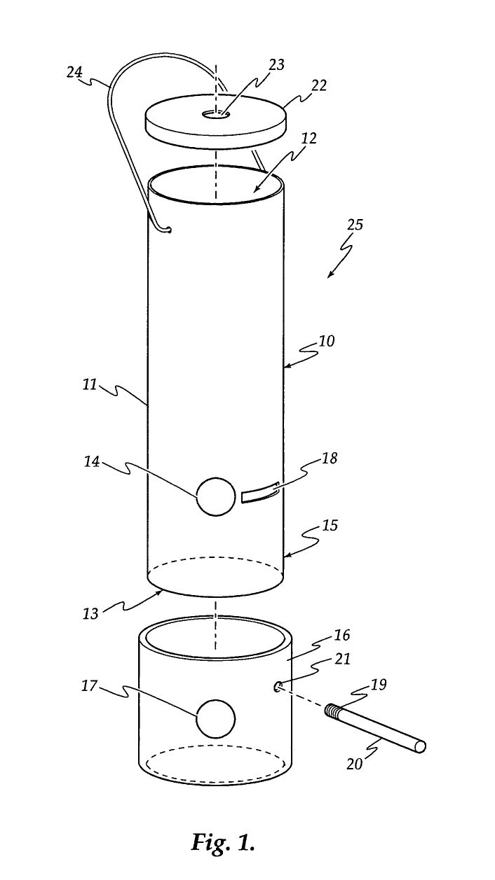

Turning first to FIG. 1, burner 25 is formed from a metal cylindrical tube 11 having an open end 12 and a closed end 13. Aperture 14 is located near closed end 13. The space between aperture 14 and open end 12 constitutes the combustion chamber 10 and effectively comprises a flue. The space between aperture 14 and closed end 13 constitutes ash chamber 15.

Sleeve 16 has an internal diameter slightly greater than the external diameter of tube 11 and has an aperture 17 of similar size to aperture 14 in tube 11. The external surface of tube 11 carries a circumferential groove 18 adapted to receive radially inward projection 19 of a radial arm 20 when arm 20 is screwed or otherwise fixed in locating aperture 21 in sleeve 16. The location of projection 19 in groove 18 allows sleeve 16 to be rotated about tube 11 by means of arm 20.

Aperture 14 constitutes an air inlet to combustion chamber 10, the intake of air through the air intake being varied by rotating sleeve 16 on tube 11. Air intake is maximal when apertures 14 and 17 are concentric, and the air intake reduces to zero when the apertures do not align and aperture 17 covers the outer surface of tube 11.

Cap 22 has an aperture 23 and can be fitted on open end 12 of tube 11. A lifting handle 24 allows the burner 25 to be lifted, by the fingers when it is cool, or by tongs or the like when hot.

It will be appreciated that tube 11 and sleeve 16 could have cross sectional shapes other than circular, for example square or hexagonal. In such configuration, groove 18 would extend in an axial direction along the external wall of tube 11, and sleeve 16 would similarly move in an axial direction.

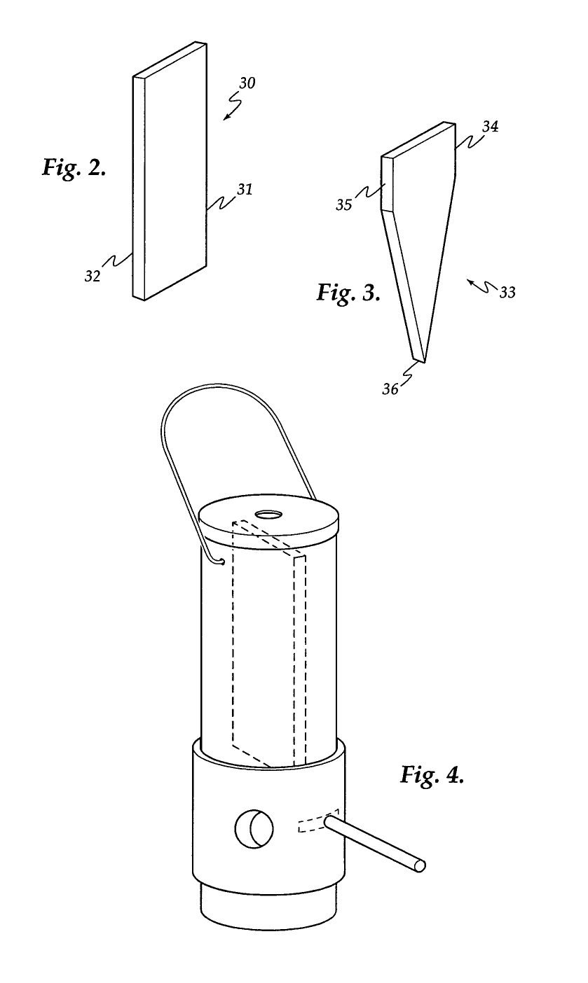

Turning now to FIG. 2, combustible wafer 30 is made from an odoriferous material. The preferred material is compressed shredded eucalyptus leaves and twigs as described in my earlier petty patent. It will be appreciated that the combustabilty of the wafer will depend on a number of factors for a given material and a given air intake setting. These factors include the packing density of the material, dampness and the thickness of the wafer—the damper and denser the material and the thicker the wafer, the less combustible the wafer will be.

As illustrated, wafer 30 is substantially rectangular with two edges 31 and 32 of the rectangular wafer being spaced apart a distance which is slightly greater than the inside diameter of tube 11.

In one preferred embodiment, tube 11 is 110 mm in length and has an internal diameter of 34.5 mm. For such a combustion chamber, wafer 30 is suitably 3 mm thick, approx 60 mm long and has a width of 35 mm, allowing the wafer to be slid into tube 11 through open end 12 where it is held in position by edges 31,32 engaging the internal surface of tube 11 due to the slight oversizing of the width of wafer 30 relative to the inner diameter of tube 11. The material from which the wafer is made is sufficiently resilient so that it compresses when the wafer is slid into the tube, and the wafer bears against the inner surface and is held in position ready for combustion.

As seen in FIG. 3, an alternative design for wafer 33 has short parallel sides 34 and 35, which taper to a point 36. This arrangement, when placed in the burner with point 36 uppermost, will result in the wafer falling relatively quickly into the ash pit where it will smoulder more slowly.

The wafers are typically prepared by crushing eucalyptus leaf, such as Tasmanian Blue Gum (Eucalyptus globulus), and rolling and pressing the crushed mass into a biscuit which is then cut to size and shape in accordance with the size of the vertical smoker. The processed materials allow for the mixing and blending of leaf and wood of different species to produce a desired effect. Artificial ingredients can also be included and the density of the wafer is affected by both particle size in the material and the rolling pressure. The shape of the wafer can determine how long it is held within the combustion chamber before falling into the ash pit. A tapered wafer for example, will fall sooner into the ash pit where it will burn more slowly.

Using water as a medium, the preferred ingredients such as eucalypt leaves, wood fines etc, are pulverised, mixed and blended to form a fibrous, pliable mass. The degree of pulverisation will affect particle size thereby determining the characteristics of the end product. The resultant mass is spread evenly within the side walls of an open-ended channel of predetermined depth which has been lined with a removable plastic film.

A stepped roller is used to compress the mass with a rolling downward pressure whereby the small outer diameter of the roller engages with the upper surface of side walls of the channel to give a constant depth limit, while the stepped inner greater diameter of the roller fits within and is guided by the side walls of the channel as the roller moves along the channel backwards and forwards. Variation of the inner stepped diameter of the roller allows for varied compression values, increasing sequentially the density of the material. Conversely, the outer roller diameter may be varied for the same result. Incompressible fluids exude from the mass through the open ends of the channel.

The material thus compressed forms a rigid wet board which is dislodged by inverting the open-ended channel whence the board and plastic film disengages from the channel under the influence of gravity. The plastic film is remeoved to facilitate drying of the board which subsequently may be cut to shape and size by conventional methods such as guillotining. The configuration of these segments pre-disposes them for use in a specialised vertical smoker/burner as previously described.

The density of the dried material affects burn rate and smoke quality in accordance with particle size and rolling pressure, which, as previously described, can be varied to vary product characteristics.

This above process allows for control in specifying the performance of a smoulderable product for purposes including food smoking and insect control. In this respect, it should be noted that no artificial fire promotants such as saltpetre, are required.

In use, the wafer is inserted snugly in the combustion chamber until none protrudes from the open ended top, and is ignited by inserting a lighted match through the air intake. When the wafer is smouldering vigorously, the burner can be placed beneath a kettle type barbeque with the vents open, or inside a conventional patio style barbeque. The system will impart smokey flavours to the food being cooked in the barbeque. The extent of smoked flavour can be decreased or increased by varying the position of the air intake control, or capping or uncapping the open end. Other factors affecting the burn time of the wafer are length, thickness, dampness and density of the wafer and the quantity of air flow through air intake 12.

It will be realised that the present invention has a number of advantages over known smoking systems. The design of the combustion chamber wherein the charge is held in and smoulders in a holder, the holder itself being a flue which constitutes the combustion chamber, eliminates the requirement for the burner to have a hearth and makes lighting the charge easier and quicker, and results in a lower cost product.

It will of course be realised that whilst the above has been given by way of an illustrative example of this invention, all such and other modifications and variations hereto, as would be apparent to persons skilled in the art, are deemed to fall within the broad scope and ambit of this invention as is herein set forth.

1. A smoking system comprising:
a burner having a combustion chamber, and
a combustible charge for combustion therein;
wherein:
the combustion chamber is a flue having an adjustable air inlet, and
the combustible charge is shaped to frictionally engage the walls of the flue to be supported thereby within the flue, and is made from an odoriferous smoke generating material and is adapted to smoulder during combustion within the flue.

2. A smoking system as claimed in claim 1, and including an ash chamber, wherein the ash chamber and the combustion chamber constitute a tube open at one end and extending beyond an aperture which constitutes the air inlet to a closed end, the space between the closed end and the aperture constituting the ash chamber and the space between the open end and the aperture constituting the combustion chamber.

3. A smoking system as claimed in claim 2, wherein the adjustable air inlet includes a sleeve with an aperture, the sleeve being moveable relative to the tube so that the passageway formed by overlap of the sleeve aperture and the tube aperture varies in accordance with the position of the sleeve.

4. A smoking system as claimed in claim 2, further comprising a removable cap to cover the open end of the tube, the cap having an aperture therein.

5. A smoking system as claimed in claim 1, wherein the combustible charge is substantially plate- or wafer-like.

6. A smoking system as claimed in claim 5, wherein the substantially plate- or wafer-like combustible charge has two opposed substantially parallel edge portions spaced apart a distance slightly greater than the internal diameter of the tube such that the charge is supported in the tube along the opposed edge portions.

7. A smoking system as claimed in claim 2, wherein the combustible charge is substantially plate- or wafer-like.

8. A smoking system as claimed in claim 7, wherein the substantially plate- or wafer-like combustible charge has two opposed substantially parallel edge portions spaced apart a distance slightly greater than the internal diameter of the tube such that the charge is supported in the tube along the opposed edge portions.
